(19) United States
(12) Patent Application Publication
(10) Pub. No.: US 2026/0310732 A1
(43) Pub. Date: Oct. 8, 2026

(54) OFFLINE MODE FOR SERVER-BASED FORMULAS

(71) Applicant: SAP SE, Walldorf (DE)

(72) Inventors: Stephane Coze, Conflans Sainte Honorine (FR); Laurent LE Floch, Magny En Vexin (FR); Bing Sun, Saint Germain En Laye (FR); Florent Migeon, Chatellerault (FR)

(21) Appl. No.: 19/170,670

(22) Filed: Apr. 4, 2025

(51) Int. Cl. G06F 16/93

(52) U.S. Cl. CPC G06F 16/93

(57) ABSTRACT

A document that makes use of server-based formulas may be switched between online and offline modes. When the document is placed in the offline mode, an add-in searches for server-based formulas and evaluates those formulas to get a current value for each one. The document is modified to replace each server-based formula with an offline formula that evaluates to the current value of the server-based formula. The server-based formula may be replaced with a conditional statement that stores the server-based formula on an unused branch of the condition. When the document is restored to the online mode, the add-in searches for the offline formulas that were generated during the previous switch to the offline mode. Each offline formula is replaced with the corresponding stored server-based formula.

### TECHNICAL FIELD

The subject matter disclosed herein generally relates to an offline mode for server-based formulas. Specifically, the present disclosure addresses systems and methods to improve computing performance by modifying local documents to support an offline mode.

### BACKGROUND

Modern computing systems frequently rely on distributed architectures where data and processing are split between client devices and servers. Documents (e.g., spreadsheets) containing formulas that reference server-based data present unique technical challenges for system performance and usability. When network connectivity is interrupted or unavailable, the inability to access server-based data can prevent proper formula evaluation and document rendering. This creates technical problems related to data persistence, formula processing, and maintaining document functionality across different network states.

Additionally, the growing complexity of enterprise software that operates in both local and cloud-based modes introduces technical challenges around maintaining consistent formula evaluation and data access across different operating environments. The technical nature of these challenges requires solutions that can effectively manage formula processing, data caching, and state transitions while preserving document integrity and functionality.

### BRIEF DESCRIPTION OF THE DRAWINGS

Some embodiments are illustrated by way of example and not limitation in the figures of the accompanying drawings.

FIG. 1 is a network diagram illustrating a network environment suitable for implementing an offline mode for server-based formulas, according to some example embodiments.

FIG. 2 is a block diagram of a server, according to some example embodiments, suitable for supporting server-based formulas.

FIG. 3 is a block diagram of a client device, according to some example embodiments, suitable for implementing server-based formulas in online and offline modes.

FIG. 4 is a block diagram of elements of clients and servers, according to some example embodiments, suitable for implementing server-based formulas in online and offline modes.

FIG. 5 is a flowchart of a method, according to some example embodiments, suitable for implementing an offline mode for server-based formulas.

FIG. 6 is a flowchart of a method, according to some example embodiments, suitable for returning a workbook to an online mode.

FIG. 7 is a flowchart of a method, according to some example embodiments, suitable for implementing an offline mode for server-based formulas.

FIG. 8 is a block diagram illustrating components of a computing device, according to some example embodiments.

### DETAILED DESCRIPTION

Example methods and systems are directed to implementing an offline mode for server-based formulas through technical modifications to document processing systems. A document (e.g., a spreadsheet workbook) containing server-dependent formulas is programmatically modified to enable state transitions between online and offline processing modes through an add-in component (also referred to as a plug-in) that extends the host system's computational capabilities. The add-in may be integrated into various technical environments including web browsers, software applications, interactive development environments (IDEs), operating systems, or combinations thereof to provide formula transformation capabilities.

An add-in is code or an executable object that provides functionality through a host application. For example, an add-in may provide additional features, alter the functionality of existing features, or both. Similarly, an add-in may provide additional menu options, remove menu options, alter menu options, or any suitable combination thereof. For example, an add-in may open a tab in a browser and render its user interface in the tab using the rendering engine of the browser, its own rendering engine, or both. The add-in may use the rendering engine of the browser by generating code (e.g., HTML, cascading style sheets (CSS), or JavaScript) and passing the code to the rendering engine of the browser. Additionally or alternatively, the add-in may use the rendering engine of the browser by modifying the domain object model (DOM) used by the browser. A rendering engine of the add-in may be wholly or partially implemented using a native UI control library of the add-in. An add-in may correspond to one or more activities of the application.

The add-in implements a technical framework for extending host application functionality through programmatic integration. The add-in's architecture enables it to modify core application features, alter system functionality, and implement custom processing logic. For example, the add-in can leverage browser rendering engines through programmatic DOM manipulation and code generation (HTML, CSS, JavaScript), or implement native UI controls through direct system integration. This technical flexibility allows the add-in to adapt its formula processing capabilities across different runtime environments.

When processing server-based formulas, the system executes network requests to retrieve data values. Network connectivity failures prevent data access, resulting in formula evaluation errors that impact document processing.

The add-in implements technical solutions through programmatic modifications to document structure and formula processing. Upon activation of offline mode, the add-in executes formula detection algorithms to identify server-dependent calculations and evaluates them through server data requests. The document's internal structure is programmatically modified to implement offline formula representations that maintain computational accuracy while preserving original definitions.

As described herein, an add-in may provide a user interface that allows a user to toggle between online and offline modes for a document. When the document is placed in the offline mode, the add-in searches for server-based formulas and evaluates those formulas to get a current value for each one. The document is modified to replace each server-based formula with an offline formula that evaluates to the current value of the server-based formula while storing the server-based formula.

For example, server-based formulas may access server data using a GetData( ) call. The add-in performs syntactic analysis to detect the GetData( ) calls and implements technical transformations of the formula structure. For example, a “GetData(x)” formula returning “FOO” is transformed into “IF(TRUE, “FOO”, GetData(x))” to maintain result integrity while preventing server requests.

During online mode restoration, the add-in executes detection algorithms to identify previously generated offline formulas. Each offline implementation is programmatically replaced with its original server-based formula through analysis of the conditional statement structure. This enables seamless transitions between online and offline processing states.

As a result of the ability to toggle between online and offline modes, documents that include server-based formulas remain usable even when the computer system used for viewing or editing the documents is offline, when the server providing data for the formulas is offline, or both. This technical implementation enables documents with server-based formulas to maintain processing capabilities across network states, preserving functionality when client systems lose network access or servers become unavailable. The solution directly improves computing system performance and reliability. Accordingly, the functioning of the viewing or editing computer itself is improved.

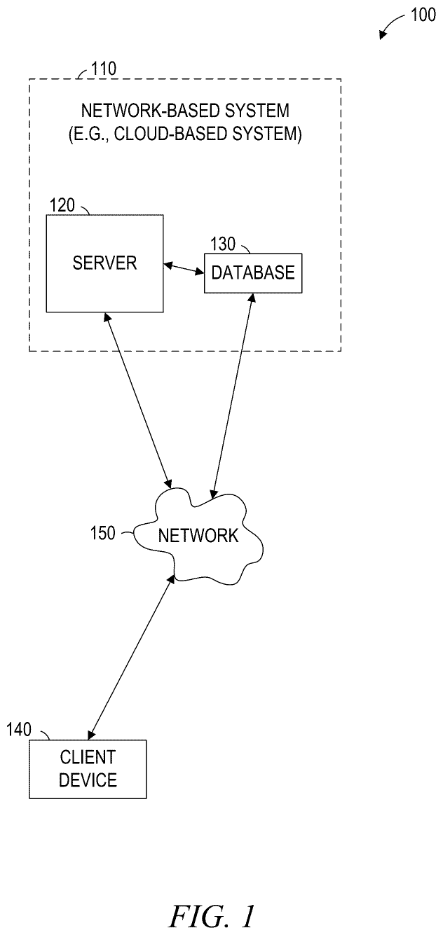

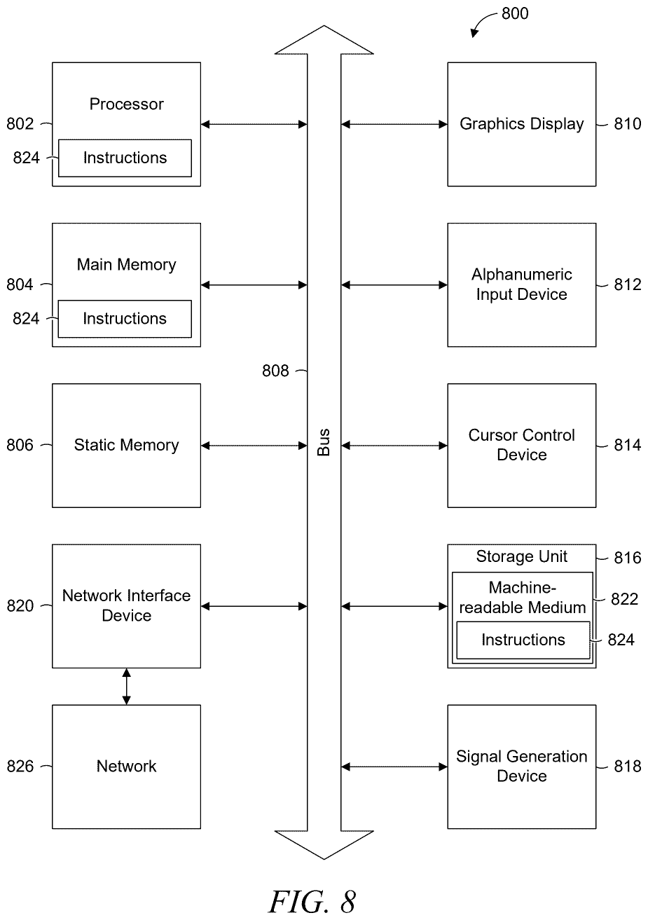

FIG. 1 is a network diagram illustrating a network environment 100 suitable for implementing an offline mode for server-based formulas, according to some example embodiments. The network environment 100 includes a server 120, a database 130, a client device 140, and a network 150. The server 120 and the database 130 may collectively comprise a network-based system 110 (e.g., a cloud-based system) capable of providing data to be used in formulas in a document processed by an application on the client device 140. The client device 140 receives the data from the network-based system 110. The server 120 may host an application capable of dispatching data and database queries to the database 130. The server 120, the database 130, and the client device 140 may each be implemented in a computer system, in whole or in part, as described below with respect to FIG. 8.

The client device 140 may include an add-in for the application that enables documents to be switched between online and offline modes. In the online mode, data for formulas is accessed from the server 120. In the offline mode, values for formulas are cached and the stored values are used for display in the document.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 8. As used herein, a “database” is a data storage resource and may store data structured as a text file, a table, a spreadsheet, a relational database (e.g., an object-relational database), a triple store, a hierarchical data store, document-oriented NoSQL databases, a file store, or any suitable combination thereof. The database may be an in-memory database. Moreover, any two or more of the machines, databases, or devices illustrated in FIG. 1 may be combined into a single machine, and the functions described herein for any single machine, database, or device may be subdivided among multiple machines, databases, or devices.

The network-based system 110 and the client device 140 are connected by the network 150. The network 150 may be any network that enables communication between or among machines, databases, and devices. Accordingly, the network 150 may be a wired network, a wireless network (e.g., a mobile or cellular network), or any suitable combination thereof. The network 150 may include one or more portions that constitute a private network, a public network (e.g., the Internet), or any suitable combination thereof.

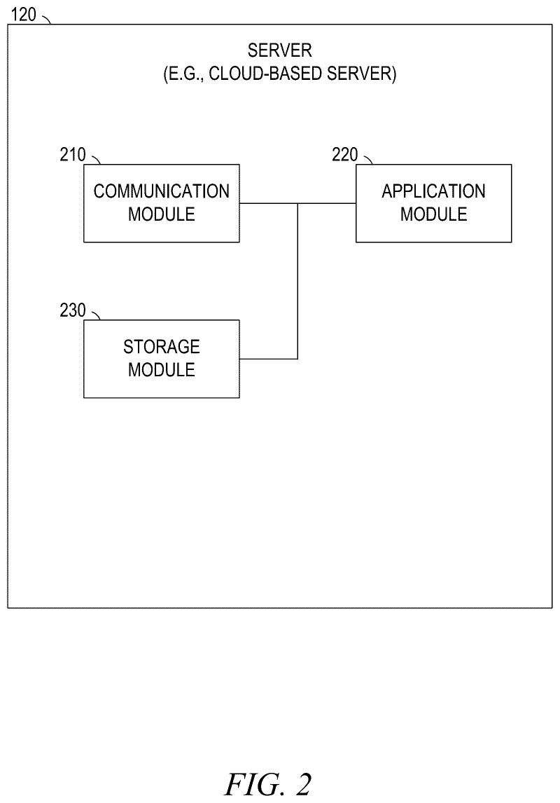

FIG. 2 is a block diagram of the server 120, according to some example embodiments, suitable for supporting server-based formulas. The server 120 is shown as including a communication module 210, an application module 220, and a storage module 230, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the server 120 and transmits data from the server 120. For example, requests for data or code may be received from the client device 140 for use in presenting a user interface to a user. Requests for data, code, or executable objects to be used in an application, cached on the client device, or both may also be received from the client device 140.

The application module 220 processes the received requests and generates appropriate responses to be sent to the client device 140 by the communication module 210. For example, the application module 220 may implement a web server that responds to hypertext transport protocol (HTTP) requests and generates HTTP responses.

The storage module 230 stores data used for some or all responses provided by the application module 220. Additionally, the storage module 230 may store some or all requests received from the client device 140. For example, data for web pages and add-ins may be stored via the storage module 230 in one or more files or databases.

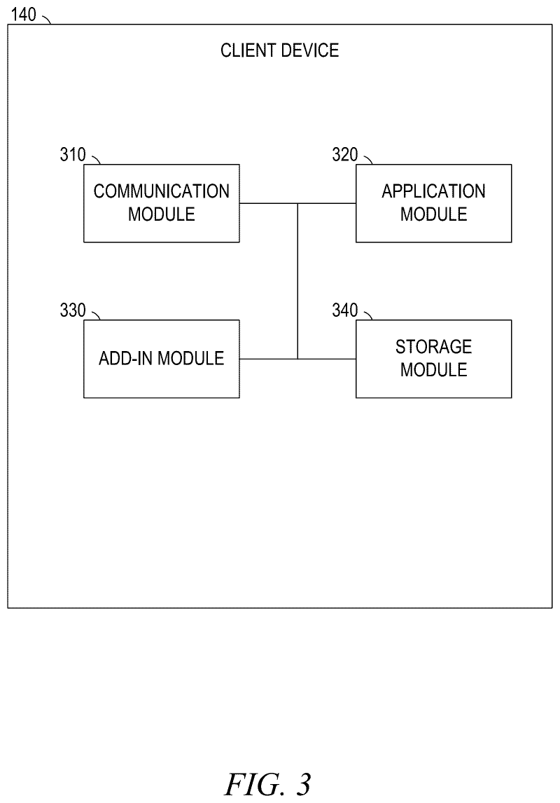

FIG. 3 is a block diagram of the client device 140, according to some example embodiments, suitable for implementing server-based formulas in online and offline modes. The client device 140 is shown as including a communication module 310, an application module 320, an add-in module 330, and a storage module 340, all configured to communicate with each other (e.g., via a bus, shared memory, or a switch).

The communication module 310 receives data sent to the client device 140 and transmits data from the client device 140. For example, a data request (e.g., an HTTP request) may be sent from the client device 140 to the server 120. The requests sent by the communication module 310 may be generated by the application module 320, the add-in module 330, or both. In some example embodiments, the application module 320 or the add-in module 330 initiates the data request and the communication module 310 executes the data request. In other example embodiments, the application module 320 or the add-in module 330 initiates and completes the data request.

The application module 320 implements an application on the client device 140. For example, the application may be a word processing application, a web browser application, a spreadsheet application, or any suitable combination thereof. The application may generate instructions to a graphics processor which, in turn, causes a user interface to be presented on a screen (e.g., a liquid crystal display (LCD) screen, a cathode ray tube (CRT) screen, or multiple display devices that combine to create a logical screen).

The add-in module 330 extends or modifies the application implemented by the application module 320. For example, the add-in module 330 may provide additional menu options to a user, data processing options to the application, or both. The storage module 340 stores data in a memory of the client device 140, retrieves data from the memory of the client device 140, or both. The storage module 340 may store cached data for the application module 320, the add-in module 330, or both.

According to various example embodiments, one or more of the methodologies described herein may switch a document between online and offline modes using an add-in. The offline mode may allow a document with server-based formulas to continue to display reasonable values for the formulas even while unable to reach the server 120 to retrieve data used in the formulas. As a result, the functioning of the client device 140 itself is improved, as compared to systems that display error messages or are unable to continue when unable to communicate with the server 120.

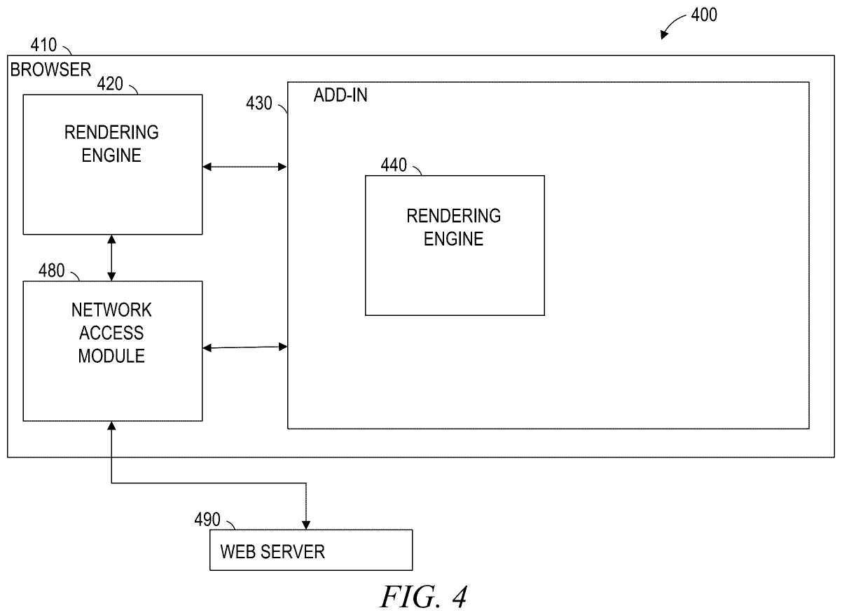

FIG. 4 is a block diagram 400 of elements of clients and servers, according to some example embodiments, suitable for implementing server-based formulas in online and offline modes. FIG. 4 shows a logical relationship between the application module 320, the add-in module 330, and the network-based system 110, exemplified in FIG. 4 as a browser 410, an add-in 430, and a web server 490, respectively. As shown in FIG. 4, the browser 410 includes a rendering engine 420, a network access module 480, and the add-in 430.

The rendering engine 420 renders data in a document. When formulas in the document are in an online mode, data for the formulas may be received from the web server 490 via the network access module 480 for processing and display. When formulas in the document are in an offline mode, data to be displayed is stored in the document and the web server 490 is not accessed to retrieve the data.

In some example embodiments, the browser 410 includes an installation mechanism for installing add-ins. In other example embodiments, the installation of the add-in 430 is performed by a separate application. For example, the add-in 430 may be installed using an installation application other than the browser 410 that places add-in object files in a location accessible by the browser 410, alters a configuration of the browser 410 such that the browser 410 will load the add-in 430, or both.

In some example embodiments, a UI generated by the add-in 430 may be displayed on a display of the client device 140 via the rendering engine 420. For example, the add-in 430 may generate or modify a domain object model which is processed by the rendering engine 420 to generate a native user interface under an operating system of the client device 140. Alternatively or additionally, a UI generated by the add-in 430 may be displayed on the display device via a rendering engine 440. For example, the add-in 430 may generate the native user interface under the operating system of the client device 140 without going through the intermediate step of generating or modifying a domain object model. In some example embodiments, using the rendering engine 420 simplifies the development, reduces the size, or both, of the add-in 430, which may not include the rendering engine 440. In some example embodiments, using the rendering engine 440 improves the performance of the add-in 430, reduces consumption of resources of the client device 140, or both.

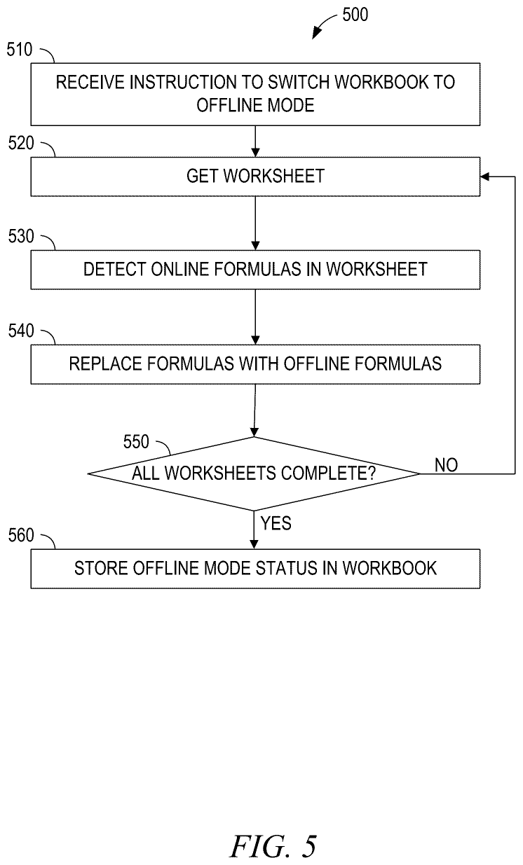

FIG. 5 is a flowchart of a method 500 that includes operations 510, 520, 530, 540, 550, and 560, according to some example embodiments, suitable for implementing an offline mode for server-based formulas. By way of example and not limitation, the method 500 is described as being performed by the client device 140 using the modules shown in FIG. 3.

In operation 510, the add-in module 330 or the application module 320 receives an instruction to switch a workbook to an offline mode. For example, the instruction may be received via a UI element that is operable to toggle the workbook between an online mode and the offline mode.

The add-in module 330 gets a worksheet of the workbook in operation 520. In operation 530, the add-in module 330 detects one or more online formulas in the worksheet. For example, formulas that access data from a server may include a GetData( ) command. Thus, all formulas in the worksheet may be parsed to determine if they include a GetData( ) call. Those that do include a GetData( ) call are online formulas. An example online formula is:
GetData (“Table1”, “Dimension1”, “Member1”, “Dimension2”, “Member1”)

The worksheet is modified by the add-in module 330 to replace the online formulas with offline formulas (operation 540). A current value of the online formula may be determined by accessing the server. The offline formula may display the current value of the online formula and encapsulated the online formula in an unused branch of a conditional statement. For example, if the current value of the GetData( ) call is 100, a corresponding example offline formula is:
IF (TRUE, 100, “GetData (“Table1”, “Dimension1”, “Member1”, “Dimension2”, “Member1”) ”)

In the above formula, the first element of the IF command is the condition to be checked, the second element is the statement to be evaluated if the condition is true, and the third element is the statement to be evaluated if the condition is false. Since the condition is simply set to TRUE, the first element is always evaluated, but the complete GetData( ) command is safely stored in the second element.

In some example embodiments, multiple commands are used to access online data. For example, a GetData( ) command may be used to read online data and a SetData( ) command may be used to write online data. Accordingly, the detecting of the online formulas my include searching for each of the multiple commands.

In operation 550, the add-in module 330 determines if all worksheets are complete. If not, the method 500 returns to operation 520 to get a next worksheet and operations 530 and 540 are repeated for that worksheet. This process continues until all worksheets are complete.

Once all worksheets are complete, the method 500 continues to operation 560. In operation 560, the add-in module 330 stores the offline mode status in the workbook. For example, a metadata value for the workbook may indicate whether the workbook is in the online mode or the offline mode. In some example embodiments, a persistency layer of the document is modified to indicate that the document is in the offline mode.

After the method 500 is complete, the application module 320 will process the workbook and automatically execute the offline formulas to render the workbook without accessing the server to retrieve data. Though the method 500 is described as operating on a workbook comprising multiple worksheets, the steps of detecting online formulas and replacing them with offline formulas may be performed on any type of document.

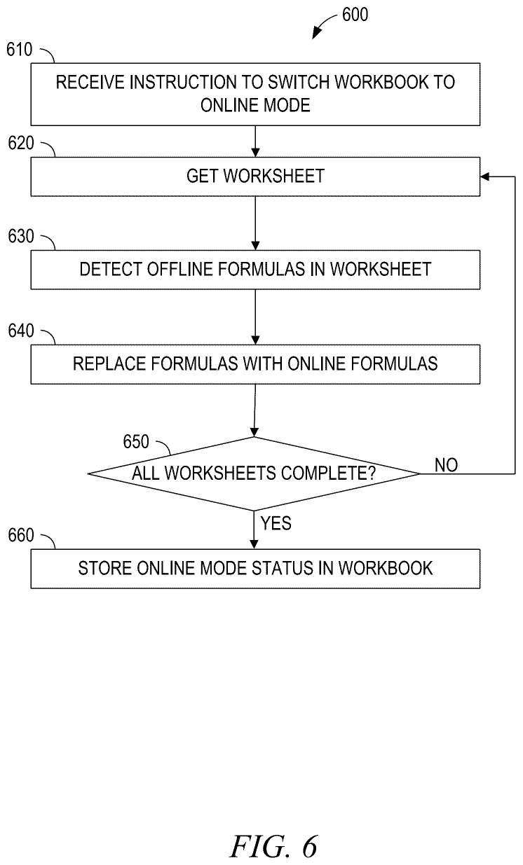

FIG. 6 is a flowchart of a method 600, according to some example embodiments, suitable for returning a workbook to an online mode. By way of example and not limitation, the method 500 is described as being performed by the client device 140 using the modules shown in FIG. 3. The method 600 may be performed after the method 500 of FIG. 5.

In operation 610, the add-in module 330 or the application module 320 receives an instruction to switch a workbook to the online mode. For example, the instruction may be received via a UI element that is operable to toggle the workbook between an online mode and the offline mode.

The add-in module 330 gets a worksheet of the workbook in operation 620. In operation 630, the add-in module 330 detects one or more offline formulas in the worksheet. For example, formulas that access data from a server may include a GetData( ) command. Thus, all formulas in the worksheet may be parsed to determine if they include a GetData( ) call in an unused branch of a conditional statement. Those that do include a GetData( ) call are online formulas. An example offline formula is:
IF (TRUE, “foo”, GetData (‘x’) )

The worksheet is modified by the add-in module 330 to replace the online formulas with offline formulas (operation 640). The offline formula may be replaced with the formula stored in the unused branch of the conditional statement. For the preceding example offline formula, the resulting online formula is:
GetData (‘x’)

In operation 650, the add-in module 330 determines if all worksheets are complete. If not, the method 600 returns to operation 620 to get a next worksheet and operations 630 and 640 are repeated for that worksheet. This process continues until all worksheets are complete.

Once all worksheets are complete, the method 600 continues to operation 660. In operation 660, the add-in module 330 stores the online mode status in the workbook. For example, a persistency layer of the document may be modified to indicate that the document is in the online mode.

After the method 600 is complete, data used in the online formulas will be accessed from the server. Thus, the methods 500 and 600 may be used to switch a workbook back and forth between an online and an offline mode. Though the method 600 is described as operating on a workbook comprising multiple worksheets, the steps of detecting offline formulas and replacing them with online formulas may be performed on any type of document.

The application itself may be provided in both a local version that runs on the client device 140 and a client-server (or cloud) version that primarily runs on the server 120. The client-server version uses the client device 140 primarily as a display device and an input device, while processing is performed primarily on the server 120. A document may be created using the client-server version, then downloaded to the client device 140, further modified using the local version, re-uploaded to the server 120, further modified using the client-server version, and so on. In some example embodiments, the add-in that is used to switch a document between online and offline modes can be used in both the local version of the application and the client-server version without modification. For example, the application may support add-ins written in JavaScript that can be run by both the local version of the application and the client-server version of the application.

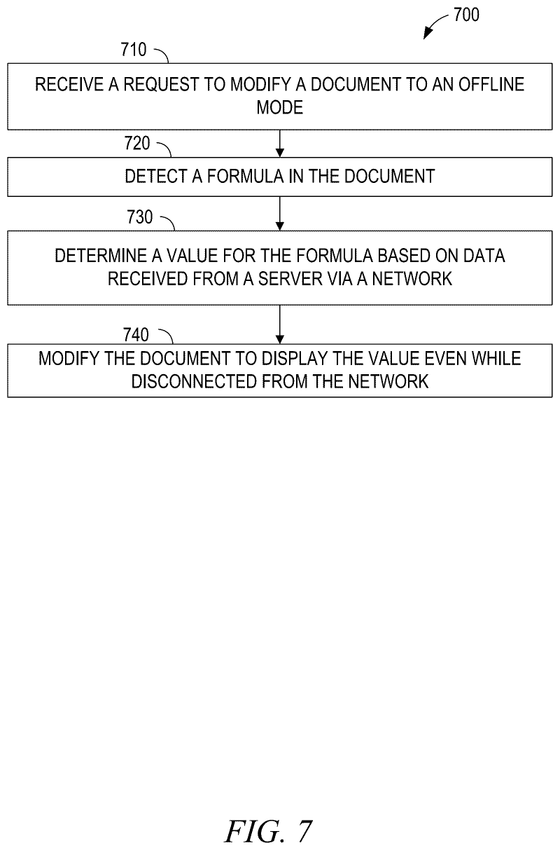

FIG. 7 is a flowchart of a method 700, according to some example embodiments, suitable for implementing an offline mode for server-based formulas. By way of example and not limitation, the method 700 is described as being performed by the client device 140 using the modules shown in FIG. 3.

In operation 710, the add-in module 330 receives a request to modify a document to an offline mode. For example, the add-in module 330 or the application module 320 may display a user interface that indicates whether the document is currently in an online mode or an offline mode. The user interface may include a button, checkbox, or other UI element that allows the user to toggle between the online and offline modes. In response to a user interaction with the UI element, the add-in module 330 receives the request to modify the document to the offline mode.

The add-in module 330, in operation 720, detects a formula in the document. In some example embodiments, detecting the formula involves searching the document for predefined strings of characters, such as “GetData.” The detecting of the formula in the document may be part of detecting all formulas in the document that depend on data received from a server.

In operation 730, the add-in module 330 or the application module 320 determines a value for the formula based on data received from a server (e.g., the server 120 of FIG. 1) via a network (e.g., the network 190 of FIG. 1). The formula may include a data request that identifies data to be retrieved from the server. Thus, evaluating the formula in its online mode includes determining a value for the formula based on data received from a server.

The add-in module 330 modifies the document to display the value even while disconnected from the network (operation 740). The modifying of the document may include putting the value in an active branch of a conditional statement and storing the online formula in an inactive branch of a conditional statement.

In view of the above-described implementations of subject matter, this application discloses the following list of examples, wherein one feature of an example in isolation or more than one feature of an example, taken in combination and, optionally, in combination with one or more features of one or more further examples are also examples falling within the disclosure of this application.

Example 1 is a system comprising: one or more hardware processors; and a memory that stores instructions that, when executed by the one or more hardware processors, cause the one or more hardware processors to perform operations comprising: receiving a request to modify a document to an offline mode; and in response to the request: detecting a formula in the document; determining a value for the formula based on data received from a server via a network; and modifying the document to display the value even while disconnected from the network.

In Example 2, the subject matter of Example 1, wherein: the detecting of the formula in the document comprises determining that the formula depends on data received from the server.

In Example 3, the subject matter of Example 2, wherein: the detecting of the formula in the document is part of detecting all formulas that depend on data received from the server.

In Example 4, the subject matter of Example 3, wherein: the document comprises a workbook comprising a plurality of worksheets; and the detecting of all formulas that depend on data received from the server comprises iterating through the plurality of worksheets.

In Example 5, the subject matter of Examples 1-4, wherein the instructions are part of an add-in module that is able to function without modification in an online version of an application and an offline version of the application.

In Example 6, the subject matter of Examples 1-5, wherein the modifying of the document comprises placing the value in one branch of an IF statement and placing the formula in another branch of the IF statement.

In Example 7, the subject matter of Examples 1-6, wherein the operations further comprise: in response to the request, modifying a persistency layer of the document to indicate that the document is in the offline mode.

In Example 8, the subject matter of Example 7, wherein the operations further comprise: receiving a second request to modify the document to an online mode; and in response to the second request, restoring the formula to the document.

In Example 9, the subject matter of Example 8, wherein the operations further comprise: in response to the second request, modifying the persistency layer of the document to indicate that the document is in the online mode.

Example 10 is a method comprising: receiving, by one or more hardware processors, a request to modify a document to an offline mode; and in response to the request: detecting a formula in the document; determining a value for the formula based on data received from a server via a network; and modifying the document to display the value even while disconnected from the network.

In Example 11, the subject matter of Example 10, wherein: the detecting of the formula in the document comprises determining that the formula depends on data received from the server.

In Example 12, the subject matter of Example 11, wherein: the detecting of the formula in the document is part of detecting all formulas that depend on data received from the server.

In Example 13, the subject matter of Example 12, wherein: the document comprises a workbook comprising a plurality of worksheets; and the detecting of all formulas that depend on data received from the server comprises iterating through the plurality of worksheets.

In Example 14, the subject matter of Examples 10-13, wherein the instructions are part of an add-in module that is able to function without modification in an online version of an application and an offline version of the application.

In Example 15, the subject matter of Examples 10-14, wherein the modifying of the document comprises placing the value in one branch of an IF statement and placing the formula in another branch of the IF statement.

In Example 16, the subject matter of Examples 10-15 includes, in response to the request, modifying a persistency layer of the document to indicate that the document is in the offline mode.

In Example 17, the subject matter of Example 16 includes receiving a second request to modify the document to an online mode; and in response to the second request, restoring the formula to the document.

Example 18 is a non-transitory machine-readable storage medium comprising instructions that, when executed by one or more processors of a machine, cause the machine to perform operations comprising: receiving a request to modify a document to an offline mode; and in response to the request: detecting a formula in the document; determining a value for the formula based on data received from a server via a network; and modifying the document to display the value even while disconnected from the network.

In Example 19, the subject matter of Example 18, wherein: the detecting of the formula in the document comprises determining that the formula depends on data received from the server.

In Example 20, the subject matter of Example 19, wherein: the detecting of the formula in the document is part of detecting all formulas that depend on data received from the server.

Example 21 is an apparatus comprising means to implement any of Examples 1-20.

FIG. 8 is a block diagram illustrating components of a machine 800, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 8 shows a diagrammatic representation of the machine 800 in the example form of a computer system and within which instructions 824 (e.g., software, a program, an application, an applet, an app, or other executable code) for causing the machine 800 to perform any one or more of the methodologies discussed herein may be executed, in whole or in part. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a distributed (e.g., peer-to-peer) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform all or part of any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a graphics display 810 (e.g., a plasma display panel (PDP), a light emitting diode (LED) display, a liquid crystal display (LCD), a projector, or a cathode ray tube [CRT]). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 via the network interface device 820.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 800), such that the instructions, when executed by one or more processors of the machine (e.g., processor 802), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface [API]).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A system comprising:
one or more hardware processors; and
a memory that stores instructions that, when executed by the one or more hardware processors, cause the one or more hardware processors to perform operations comprising:
receiving a request to modify a document to an offline mode; and
in response to the request:
detecting a formula in the document;
determining a value for the formula based on data received from a server via a network; and
modifying the document by placing the value in an active branch of a conditional statement, thereby enabling the document to display the value even while disconnected from the network.

2. The system of claim 1, wherein:
the detecting of the formula in the document comprises determining that the formula depends on data received from the server.

3. The system of claim 2, wherein:
the detecting of the formula in the document is part of detecting all formulas that depend on data received from the server.

4.) The system of claim 3, wherein:
the document comprises a workbook comprising a plurality of worksheets; and
the detecting of all formulas that depend on data received from the server comprises iterating through the plurality of worksheets.

5. The system of claim 1, wherein the instructions are part of an add-in module that is able to function without modification in an online version of an application and an offline version of the application.

6. The system of claim 1, wherein the modifying of the document comprises placing value in one branch of an IF statement and placing the formula in another branch of the IF statement.

7. The system of claim 1, wherein the operations further comprise:
in response to the request, modifying a persistency layer of the document to indicate that the document is in the offline mode.

8. The system of claim 7, wherein the operations further comprise:
receiving a second request to modify the document to an online mode; and
in response to the second request, restoring the formula to the document.

9. The system of claim 8, wherein the operations further comprise:
in response to the second request, modifying the persistency layer of the document to indicate that the document is in the online mode.

10. A method comprising:
receiving, by one or more hardware processors, a request to modify a document to an offline mode; and
in response to the request:
detecting a formula in the document;
determining a value for the formula based on data received from a server via a network; and
modifying the document by placing the value in an active branch of a conditional statement, thereby enabling the document to display the value even while disconnected from the network.

11. The method of claim 10, wherein:
the detecting of the formula in the document comprises determining that the formula depends on data received from the server.

12. The method of claim 11, wherein:
the detecting of the formula in the document is part of detecting all formulas that depend on data received from the server.

13. The method of claim 12, wherein:
the document comprises a workbook comprising a plurality of worksheets; and
the detecting of all formulas that depend on data received from the server comprises iterating through the plurality of worksheets.

14. The method of claim 10, wherein the request is received by an add-in module that is able to function without modification in an online version of an application and an offline version of the application.

15. The method of claim 10, wherein the modifying of the document comprises placing the value in one branch of an IF statement and placing the formula in another branch of the IF statement.

16. The method of claim 10, further comprising: in response to the request, modifying a persistency layer of the document to indicate that the document is in the offline mode.

17. The method of claim 16, further comprising:
receiving a second request to modify the document to an online mode; and
in response to the second request, restoring the formula to the document.

18. A non-transitory machine-readable storage medium comprising instructions that, when executed by one or more processors of a machine, cause the machine to perform operations comprising:
receiving a request to modify a document to an offline mode; and
in response to the request:
detecting a formula in the document;
determining a value for the formula based on data received from a server via a network; and
modifying the document by placing the value in an active branch of a conditional statement, thereby enabling the document to display the value even while disconnected from the network.

19. The non-transitory machine-readable storage medium of claim 18, wherein:
the detecting of the formula in the document comprises determining that the formula depends on data received from the server.

20. The non-transitory machine-readable storage medium of claim 19, wherein:
the detecting of the formula in the document is part of detecting all formulas that depend on data received from the server.
